(19) United States
(12) Patent Application Publication
(10) Pub. No.: US 2008/0244946 A1
(43) Pub. Date: Oct. 9, 2008

(54) ATTENTION GETTING ENHANCEMENT FOR A SIGN

(76) Inventor: Erick Peter, Orange, CA (US)

Correspondence Address: GANZ LAW, P.C., P O BOX 2200, HILLSBORO, OR, 97123, US

(21) Appl. No.: 12/098,181

(22) Filed: Apr. 4, 2008

Related U.S. Application Data
(60) Provisional application No. 60/910,637, filed on Apr. 6, 2007.

(51) Int. Cl. G09F 17/00; G09F 15/00

(52) U.S. Cl. 40/604; 40/584

(57) ABSTRACT

A support for an attention getting item having a first section with an anchor of which size and shape are adapted for a complementary and secure fit within or to a channel or other complementary feature of a sign or display board, and having a second section for supporting an attention getting item, such as a flag, banner, ribbons, balloons, etc., in relation to the sign or display. In an example embodiment, the attention getting item may be a sign flag having a flag, a tapered elongated anchor member, with a narrow end and a wide end, and a cylindrical member connected to the wide end of the elongated member adapted to secure the flag. The dimensions of the tapered member may be adapted to removably secure the sign flag to the internal channels of a corrugated board such that the flag remains exposed.

### RELATED APPLICATIONS

This application claims priority to and the benefit of U.S. Provisional Application Ser. No. 60/910,637 filed on Apr. 6, 2007 by Erick Peter, entitled “Attention Getting Enhancement For a Sign” the entire disclosure of which is hereby incorporated by reference as if set forth in its entirety for all purposes.

### BACKGROUND

The inventive subject matter relates to a system for enhancing attention to a sign or display. More particularly, the inventive subject matter disclosed herein relates to a support for an attention getting item, such as a sign post kit, more particularly, a sign post kit that is easy to assemble and disassemble on a corrugated board used as a display sign. This type of sign has been very effective in real estate, building, and advertising markets. These signs are usually manufactured out of a corrugated cardboard or plastic board material and attach to posts that secure the sign board to the ground. Flags are often used and attached to the board to attract attention. To attach a flag, a regular post or stick could be used. However, such a post would fall through the channels of the corrugated board, or expand and break the channel if the post or stick is too large. The sticks that are used are not designed to fit into boards with differently sized corrugated structures. Other means of attaching flags to the board, such as tape, are cumbersome to use. Accordingly, there is a need for improved sign systems that allow for convenient and secure attachment of an attention getting item.

### SUMMARY

The inventive subject matter offers a solution for these problems by providing a support for an attention getting item with the following qualities, alone or in combination.

The inventive subject matter is directed to a support for an attention getting item having a first section comprising an anchor having a size and shape adapted for a complementary and secure fit to a feature of a display board, and a second section for supporting an attention getting item in relation to the display board. In the foregoing embodiment, the anchor may be adapted to fit within a complementary feature of a display board. In the foregoing embodiment, the complementary feature may be a channel. In the foregoing embodiment, the first and second sections may be made of a flexible material.

The inventive subject matter is further directed to a system for enhancing attention to a display board, including at least one attention getting item, a support for an attention getting item having a first section comprising an anchor having a size and shape adapted for a complementary and secure fit to a feature of a display board, and a second section for supporting an attention getting item in relation to the display board. In the foregoing embodiment, the attention getting item may be a flag, banner, ribbon, or balloon.

In one possible embodiment, a sign flag may include a flag, a tapered elongated anchor member having a narrow end and a wide end, a cylindrical member connected to the wide end of the anchor member and adapted to secure the flag. The dimensions of the anchor member may be adapted to removably secure the sign flag to the internal channels of a corrugated board so that the flag is exposed.

The inventive subject matter further contemplates a kit including a corrugated display board, a flag, an anchor member having a narrow end and a wide end, and a support member connected to the wide end of the anchor member and adapted to secure the flag and wherein the dimensions of the anchor member are adapted to removably secure the flag to the internal channels of the corrugated display board so that the flag is exposed. In the foregoing embodiment, the anchor member may have a tapered elongated shape, and the support member may have a cylindrical shape.

The inventive subject matter further contemplates a method for using a support for an attention getting item, including the steps of selecting a display board, selecting a support for an attention getting item that complementary secures to the display board, selecting an attention getting item, followed by securing the attention getting item to the support, and securing the support to the display board so that the attention getting item is exposed.

These and other embodiments are described in more detail in the following detailed descriptions and the figures.

The foregoing is not intended to be an exhaustive list of embodiments and features of the inventive subject matter. Persons skilled in the art are capable of appreciating other embodiments and features from the following detailed description in conjunction with the drawings.

### BRIEF DESCRIPTION OF THE DRAWINGS

The following figures show embodiments according to the inventive subject matter, unless noted as showing prior art.

FIG. 1 shows a side view of a support for an attention getting item.

FIG. 2 shows a top view of the internal channels of a corrugated board.

FIG. 3 shows a top view of another corrugated board.

FIG. 4 shows a design for a packaging wrapper for flag poles according to the inventive subject matter and illustrates how a flag pole configuration makes a display board stand out between display boards without attention getting enhancement.

### DETAILED DESCRIPTION

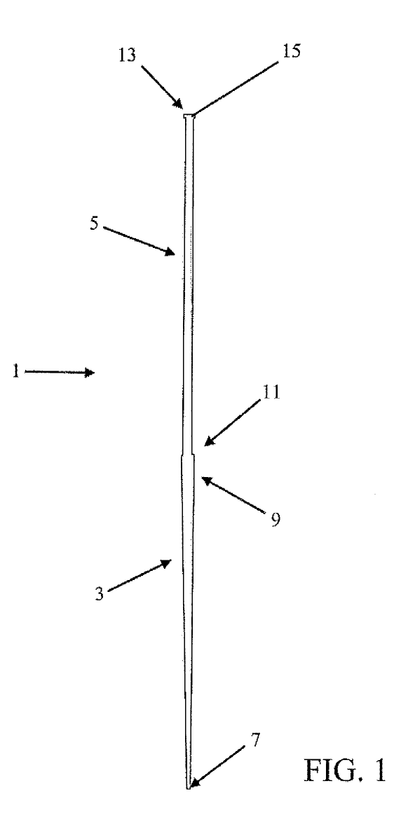

Representative embodiments according to the inventive subject matter are shown in FIGS. 1-4, wherein the same or generally similar features share common reference numerals.

A sign or display board is a board carrying information, usually used for advertising of for example products, events, houses for sale or let, etc. They are also used for cautionary or educational purposes. These boards are often made out of a corrugated material having internal channels. It may be desirable to draw attention to the display board by adding attention getting items, in the form of flags, banners, balloons, pin wheels, etc.

The inventive subject matter is directed to a novel system for enhancing attention to a display board, having at least one attention getting item and a support for such an attention getting item. The support for an attention getting item may have a first section including an anchor having a size and shape adapted for a complementary and secure fit to a feature of a display board, and a second section for supporting an attention getting item in relation to the display board. The feature of the display board may include a channel or any other shape complementary to the anchor of the support. Typically, the anchor is an elongated element that slideably and removably fits into a channel. The second section of the support supports an attention getting item such as a flag, banner, ribbons, balloons, windmills, pinwheels, etc. The support may be designed to support the attention getting item above, below, in front, or behind the sign, and in this regard, it may have a straight or bent shape, for example. The attention getting items may add visibility and interest to existing or new signs.

An example of an inventive support in the nature of a flagpole is shown in FIG. 1. The flagpole 1 may have two members, i.e., a first section in the form of an anchor member 3 and a second section in the form of a cylindrical member 5. Anchor member 3 is provided with a narrow end 7 and a wide end 9. Bottom end 11 of cylindrical member 5 is connected to wide end 9 of anchor member 3, and may have a cross-section sized to prevent the flag from sliding down. Top end 13 of member 5 is also adapted to secure the flag, for example with a wider cross-section, such as knob 15, to prevent the flag from moving upward. The dimensions of anchor member 3 are adapted to removably secure flag pole 1 to the internal channels of a corrugated board, such that the cylindrical portion of the flag pole remains exposed, and thus displaying the flag to the top of a corrugated board.

Typically the flagpole may be slideably removable. The specific dimensions allow the sign flags to fit firmly in standard corrugated boards. The specifically tapered dimensions of the anchor member allow for a secure fit in the boards and prevent that the flagpole slides through the fluted channels. For example, a flag pole with an overall length of about 11.875 inches may have an anchor member 3 with a length of about 5.875 inches and a cylindrical member 5 with a length of about 6 inches with a knob 15 at the end of the cylindrical member 5 having a length of about 0.125 inches. The narrow end 7 may have a diameter of about 0.125 inches gradually tapering into a diameter of about 0.3125 inches at the wide end 9, with a diameter of about 0.1875 inches in the middle of the anchor member. The cylindrical member 5 may have a diameter of about 0.3125 inches with a knob diameter at the end of about 0.375 inches. These are exemplary dimensions only and may be adjusted by one skilled in the art.

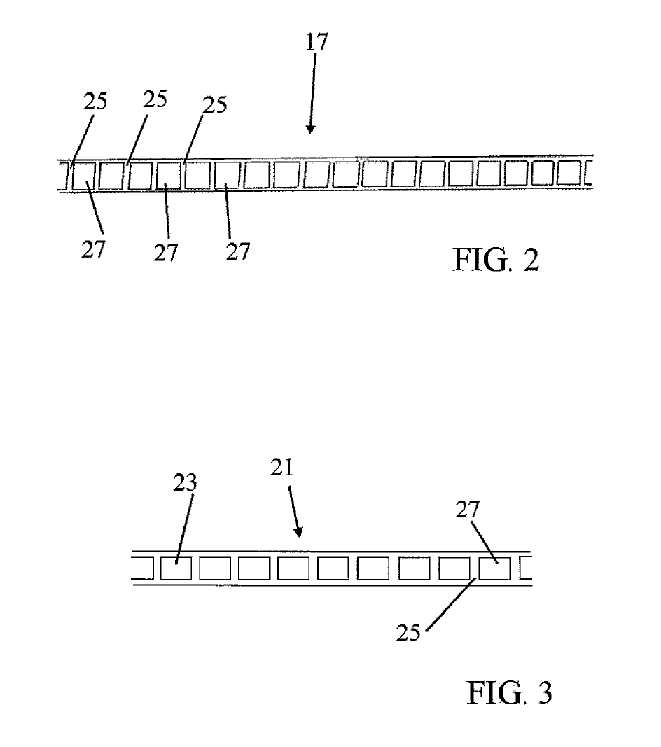

The dimensions may be adapted to facilitate insertion into the channels of standard corrugated boards such as shown in FIGS. 2 and 3, which have ribs 25 and internal cavities 27 flowing in one direction. As used herein a corrugated board refers to a board having two parallel sheets connected with multiple ribs forming channels or flutes. These boards may be made of plastic, paper or card board, or any other suitable material. For example, a corrugated plastic sign panel is an extruded twin-wall plastic sheet with internal ribs typically made of a high impact plastic. Corrugated plastic comes in different sizes, typically 4 mm and 6 mm. FIG. 2 shows an example of a corrugated board 17 having internal cavities 27, in the form of square fluted channels of 3/16″× 3/16.″ FIG. 3 shows another example of a corrugated board 21 having internal cavities 27 in the form of rectangular channels 23 of ⅛″× 3/16.″

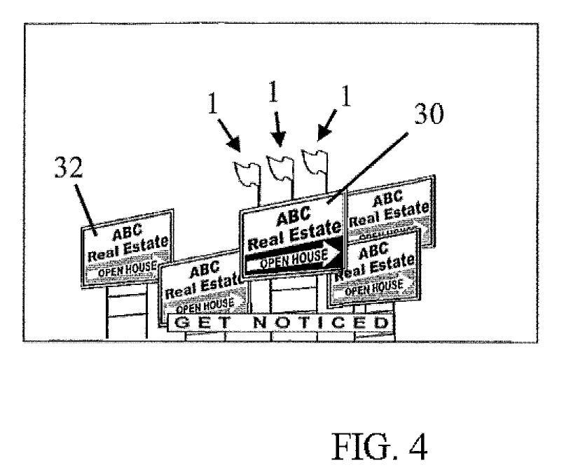

In one possible embodiment, several flag poles may be mounted on one corrugated board, depending on the size of the board used. For example, FIG. 4 shows a design for a packaging wrapper for flag poles 1, as described above, and illustrates how a flag pole configuration makes a display board 30 stand out between display boards 32 without attention getting enhancement. Here, a real estate display board 30 is provided with three sign flags 1 according to one possible embodiment of the inventive subject matter.

In other possible embodiments, flags or signs may be attached over several flagpoles, for example to support a larger sign or to provide a steady display. In other possible embodiments, several corrugated boards may be interconnected by using these pole signs.

Another example embodiment of the inventive subject matter may provide for a kit, including a corrugated display board, a flag, an anchor member having a narrow end and a wide end, and a support member connected to the wide end of the anchor member and adapted to secure the flag. The dimensions of the anchor member are adapted to removably secure the sign flag to the internal channels of the corrugated board so that the flag is exposed. For example, the anchor member may have a tapered elongated shape as described above. The support member may have a cylindrical shape as described above.

The flagpole may be made out of any suitable material, either rigid or flexible. For example, a soft flexible plastic flagpole may be used in combination with a fluted plastic board. The flagpole may also be made out of wood or metal. Additionally, the flags itself may be made of any suitable material, such cloth, paper, plastic etc. These flags also provide for wind resistant attachment to the boards, in an economical way.

The flagpole and board may also be made of materials that are frictionally engageable and allow a more secure and stable support system.

The inventive subject matter also contemplates methods for using the support, for example as flag sign or as advertising sign. The method includes the steps of selecting a display board, selecting a support for an attention getting item that complementary secures to the display board, and selecting an attention getting item. Subsequently, the attention getting item is secured to the support, and the support together with the attention getting item is secured to the display board so that the attention getting item is exposed.

Persons skilled in the art will recognize that many modifications and variations are possible in the details, materials, and arrangements of the parts and actions which have been described and illustrated in order to explain the nature of the inventive subject matter, and that such modifications and variations do not depart from the spirit and scope of the teachings and claims contained therein.

All patent and non-patent literature cited herein is hereby incorporated by references in its entirety for all purposes.

1. A support for an attention getting item, comprising:
a first section comprising an anchor having a size and shape adapted for a complementary and secure fit to a feature of a display board; and
a second section for supporting an attention getting item in relation to the display board.

2. The support of claim 1, wherein the anchor is adapted to fit within a complementary feature of a display board.

3. The support of claim 1, wherein the complementary feature is a channel.

4. The support of claim 1, wherein the first and second sections are made of a flexible material.

5. A system for enhancing attention to a display board, comprising:
at least one attention getting item;
a support for an attention getting item having a first section comprising an anchor having a size and shape adapted for a complementary and secure fit to a feature of a display board, and a second section for supporting an attention getting item in relation to the display board.

6. The system of claim 5, wherein the attention getting item is a flag.

7. The system of claim 5, wherein the attention getting item is a banner.

8. The system of claim 5, wherein the attention getting item is a ribbon.

9. The system of claim 5, wherein the attention getting item is a balloon.

10. A sign flag, comprising:
a flag;
a tapered elongated anchor member having a narrow end and a wide end;
a cylindrical member connected to the wide end of the anchor member and adapted to secure the flag; and
the dimensions of the anchor member adapted to removably secure the sign flag to the internal channels of a corrugated board so that the flag is exposed.

11. A kit comprising:
a corrugated display board;
a flag;
an anchor member having a narrow end and a wide end;
a support member connected to the wide end of the anchor member and adapted to secure the flag; and
the dimensions of the anchor member adapted to removably secure the flag to the internal channels of the corrugated display board so that the flag is exposed.

12. The kit of claim 11, wherein the anchor member has a tapered elongated shape.

13. The kit of claim 11, wherein the support member has a cylindrical shape.

14. A method for using a support for an attention getting item, comprising:
selecting a display board;
selecting a support for an attention getting item that complementary secures to the display board;
selecting an attention getting item;
securing the attention getting item to the support; and
securing the support to the display board so that the attention getting item is exposed.
